(19) United States
(12) Patent Application Publication
(10) Pub. No.: US 2014/0189604 A1
(43) Pub. Date: Jul. 3, 2014

(54) METHOD AND SYSTEM FOR UNLOCKING A TOUCHSCREEN OF AN ELECTRONIC DEVICE

(71) Applicant: INTERNATIONAL BUSINESS MACHINES CORPORATION, Armonk, NY (US)

(72) Inventors: John M. Garrison, Austin, TX (US); Michael McKay, Round Rock, TX (US)

(73) Assignee: INTERNATIONAL BUSINESS MACHINES CORPORATION, Armonk, NY (US)

(21) Appl. No.: 13/733,639

(22) Filed: Jan. 3, 2013

(51) Int. Cl. G06F 3/0488

(52) U.S. Cl. CPC G06F 3/0488
USPC 715/863

(57) ABSTRACT

A method and system for unlocking a touchscreen of an electronic device includes detecting a sequence of one or more press gestures on the touchscreen; and responsive to determining that each individual pressure gesture comprising the sequence of one or more pressure gestures is applied for a specific period of time to a specific area of the touchscreen, unlocking the touchscreen.

### BACKGROUND

Mobile computing devices today equipped with touchscreens automatically enter a sleep mode where the screen is deactivated after a short period of non-use to save power and to prevent accidental activation of device features. To wake a mobile device up from sleep mode, the user typically presses a key, such as “home” key, which reactivates the screen. As additional security, most electronic devices, particular smartphones, also include a lock screen or lock mode in which features of a mobile device are locked until a correct entry is made to “unlock” the device.

There are a variety of conventional techniques for unlocking an electronic computing device. Probably the most common technique is to require the user to enter a pin code or password in the lock screen. In more recent technique is to allow the user to swipe a predetermined pattern on the touch screen with a finger. Typically a grid of points is displayed and the user must connect some number of the points in order with a continuous swipe gesture. Another technique, typically used with laptops, is the use of biometric scanners, such as fingerprint readers that identify user's fingerprints, and retinal scanners that identify user's eyes.

Each of these approaches for unlocking the touchscreen of electronic computing devices requires the user to user look at the device (e.g., typing a PIN or password, or swiping a specific pattern), or requires special hardware support, (e.g., a fingerprint reader or retinal scanner).

Accordingly, it would be desirable to provide an improved approach for unlocking a touchscreen of an electronic device that does not require the user to look at the device or require special hardware.

### BRIEF SUMMARY

The exemplary embodiment provides methods and systems for unlocking a touchscreen of an electronic device. Aspects of exemplary environment include detecting a sequence of one or more press gestures on the touchscreen; and responsive to determining that each individual pressure gesture comprising the sequence of one or more pressure gestures is applied for a specific period of time to a specific area of the touchscreen, unlocking the touchscreen.

According to the method and system disclosed herein, the exemplary embodiments unlock the touchscreen by detecting timed pressure gestures applied to a touchscreen in specific areas, which does not require the user to look at the electronic device.

### BRIEF DESCRIPTION OF SEVERAL VIEWS OF THE DRAWINGS

FIG. 1 is a block diagram illustrating an exemplary system environment in which one embodiment for unlocking a touchscreen of an electronic device may be implemented.

FIG. 2 is a flow diagram illustrating a process for unlocking the touchscreen of electronic device according to one exemplary embodiment.

FIGS. 3, 4 and 5A-5B are diagrams illustrating exemplary sequences of one or more pressure gestures applied to a touchscreen to unlock the touchscreen.

### DETAILED DESCRIPTION

The exemplary embodiment relates to methods and systems for unlocking a touchscreen of an electronic device. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for unlocking a touchscreen of electronic device using a sequence of one or more press gestures.

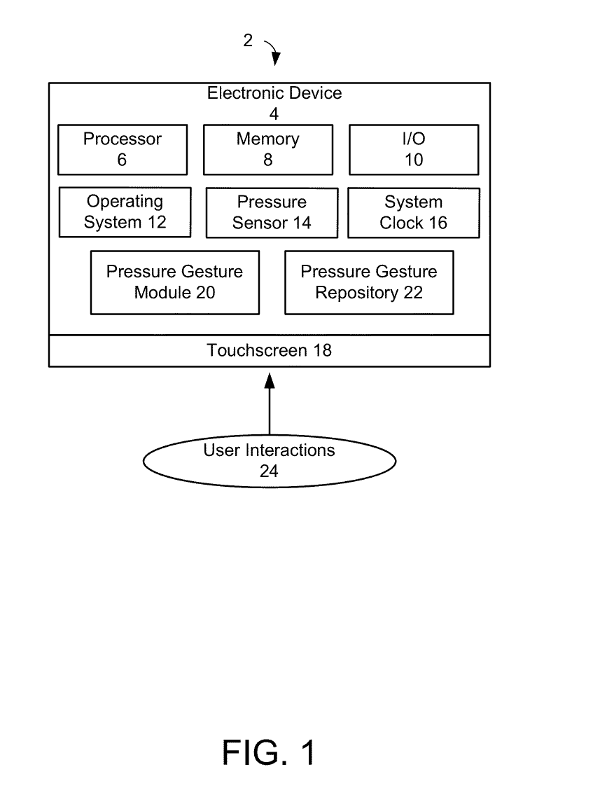

FIG. 1 is a block diagram illustrating an exemplary system environment in which one embodiment for unlocking a touchscreen of an electronic device may be implemented. The system 2 includes an electronic device 4 having at least one processor 6, a memory 8, input/output (I/O) 10, an operating system 12, a pressure sensor 14, a system clock 16, and a touchscreen 18, coupled together via a system bus (not shown).

A user may interact with the electronic device 4 using a variety of user interactions 24, including gestures made on the touchscreen 18 with a finger or stylus. In an exemplary embodiment, the touchscreen 18 on electronic device 4 may be implemented as a multi-touch display screen that has the capability to detect the presence of two or more points of contact with the surface of the screen. Multi-touch functionality has typically been used to implement common functions such as pinch and zoom or to activate programs. A conventional pressure sensor 14 is responsible for detecting the points of contact on the touchscreen and can be configured to detect an amount of pressure applied. In an alternative embodiment, the pressure sensor 14 may be replaced with a pressure sensitive film built into the touchscreen 18.

According to an exemplary embodiment, the electronic device 4 is further provided with a pressure gesture module 20 for unlocking the electronic device 4 from a lock or sleep mode. In one embodiment, the user may activate the touchscreen by pressing a hardware button causing a lock screen to appear. The pressure gesture module 20 may be responsive to reactivation of touchscreen 18 to display an unlock screen and to unlock the touchscreen if a correct sequence of one or more press gestures is applied for a predetermined time duration and on a predetermined area on the touchscreen 18. In one embodiment, the sequence of press gestures may include multi-finger press gestures. The sequence of press gestures that unlocks the touchscreen 18 may be configured by a user through the pressure gesture module 20 and may be stored in a pressure gesture repository 22.

In one embodiment, the pressure gesture module 20 comprises a software component. Although the pressure gesture module 20 is shown as a single component, it should be understood that the functions of the pressure gesture module 20 may be implemented using a different number of software components. In addition, the pressure gesture module 20 may be implemented as a separate application or as part of the operating system 12.

The electronic device 4 may be implemented as any type of touchscreen-equipped device, including, a smart or mobile phone, a tablet computer, a personal computer (e.g., desktop, laptop, or notebook), or a game system, and the like. In addition, the exemplary embodiments may be used with touchscreen devices that are installed in automobiles for navigation, climate control, entertainment, etc. The electronic device 4 may include other hardware components of typical computing devices, including input devices, such as, a keyboard, pointing device, a microphone, and buttons (not shown), and output devices, such as speakers, and the like (not shown). The memory 8 may comprise various types of computer-readable media, e.g., flash memory, hard drive, optical disk drive, magnetic disk drive, and the like, containing computer instructions that implement the functionality disclosed when executed by the processor. The electronic device 4 may further include wired or wireless network communication interfaces for communication.

The processor 6 may be part of data processing system suitable for storing and/or executing software code, which may comprise an operating system 12 and various applications. The processor 6 may be coupled directly or indirectly to elements of the memory 8 through a system bus (not shown). The memory elements can include local memory employed during actual execution of the program code, bulk storage, and cache memories which provide temporary storage of at least some program code in order to reduce the number of times code must be retrieved from bulk storage during execution.

The input/output 10 or I/O devices can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

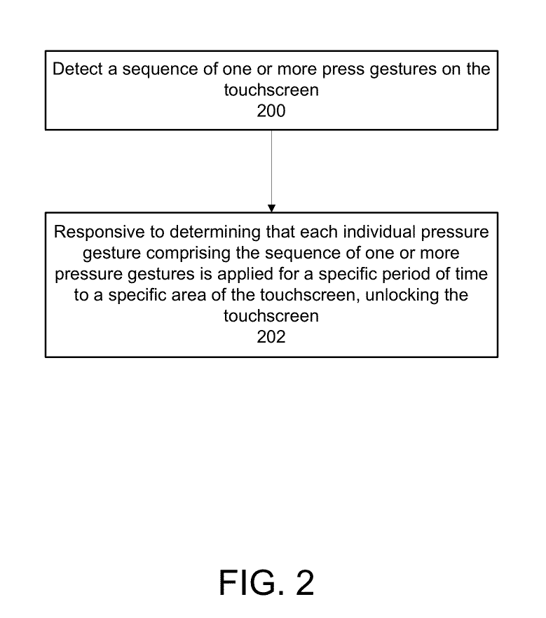

FIG. 2 is a flow diagram illustrating a process for unlocking the touchscreen of electronic device according to one exemplary embodiment. The process may begin by the pressure gesture module detecting a sequence of one or more press gestures on the touchscreen (block 200). Responsive to determining that each individual pressure gesture comprising the sequence of one or more pressure gestures is applied for a specific period of time to a specific area of the touchscreen, the pressure gesture module unlocks the touchscreen (block 202).

In one embodiment, each of the individual press gestures comprising the sequence of one or more press gestures may comprise one or more single finger presses, one or more simultaneous multi-finger presses, or any combination of single and multi-finger presses. In this embodiment, the term press gesture refers to a press and hold of a user's finger for a short period of time on the touchscreen 18, as opposed to a swipe gesture across the touchscreen 18.

In one embodiment, the attributes that may be recorded for each of the individual pressure gestures in the sequence may include:

a number of fingers in the individual pressure gesture,

a time duration of the individual pressure gesture, including both a maximum and minimum,

a position (e.g., X-Y coordinates) on the touchscreen.

In one embodiment, additional attributes may be optionally recorded, including an amount of pressure applied for each of the individual pressure gestures, and an allowed time interval between the individual pressure gestures.

In one embodiment, each of the above attributes may be specified by a user during configuration of the predetermined sequence of pressure gestures, along with additional attributes, such as defining an area of a press point applied for each of the individual press gestures, and an allowed maximum and minimum area for each of the individual press gestures. With this configuration, for example, the electronic device could be configured to be unlocked by someone with petite fingers, while someone with large fingers could not easily unlock the device.

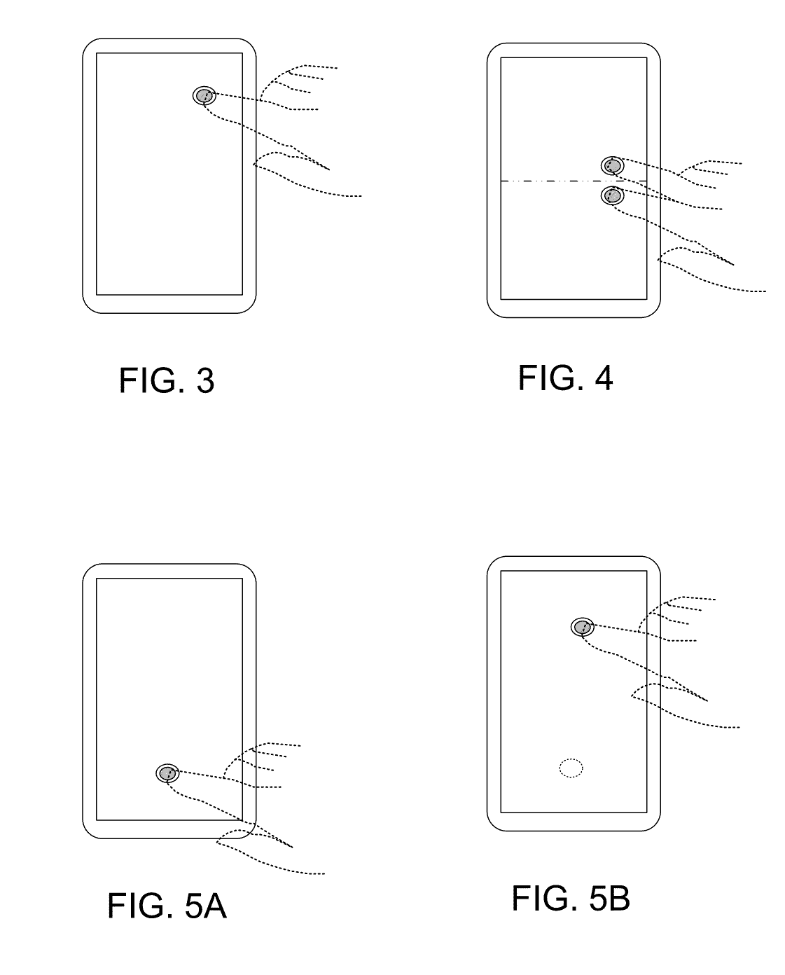

FIGS. 3, 4 and 5A-5B are diagrams illustrating exemplary sequences of one or more pressure gestures applied to a touchscreen to unlock the touchscreen. FIG. 3 is a diagram illustrating a press gesture comprising a single finger press. FIG. 4 is a diagram illustrating a press gesture comprising a simultaneous two finger press on an upper and lower half of the touchscreen for 2 to 3 seconds.

FIGS. 5A and 5B are diagrams illustrating a sequence of press gestures comprising two individual single finger press gestures. FIG. 5A shows that the first individual press gesture in the sequence comprises a single finger press in a lower half of the touchscreen for 2 seconds followed by a release. FIG. 5B shows that the second individual press gesture comprises another single finger press in an upper half of the touchscreen for 3 seconds followed by a release. In one embodiment, the second press gesture must be made within one second of the first. Although FIGS. 5A and 5B show a sequence of two individual press gestures, the sequence of press gestures may comprise any combination of single and multi-finger presses.

Other example sequences of press gestures and timing attributes may include:

Use a single digit to press the screen in the lower half of the screen for 4 seconds (give or take a configured margin of error).

Use a single digit to press the screen anywhere for 4 seconds (give or take a configured margin of error).

Tap the screen anywhere 3 times within 2 seconds.

Tap a specific Morse code-style sequence anywhere within 5 seconds using a pattern of dots (short) and dash (long) presses.

In one embodiment, the pressure gesture unlock method may be disabled if a proximity sensor with an electronic device 4 indicates the electronic device 4 is in a pocket or held near the face.

The advantage of the method and system for unlocking the touchscreen 18 using timed pressure gestures is that the user can simply tap the touchscreen to easily unlock it without typing a password, or looking at the device to perform the swipe. The approach also makes it more difficult for an observer to determine the exact sequence and timing required to unlock the phone. For example, the technique of drawing a pattern on the screen (over a grid of some sort), can be seen by an observer, and easily stolen.

The following is a more detailed description of the process for unlocking the touchscreen 18 of the electronic device 4. In one embodiment, the process may begin by the electronic device displaying a lock screen after the user has activated a hardware button while the touchscreen 18 is turned-off. In one embodiment, the lock screen may be blank, rather than the need to display any grids or user prompts. While the lock screen is displayed, the pressure sensor 14 is used to detect any pressure gestures in the form of contacts points made on the touchscreen 18 and may collect data regarding attributes of the pressure gestures.

Once the sequence of one or more pressure gestures is detected, the pressure gesture module 20 may compare the set of attributes collected for the individual pressure gestures comprising the sequence to a second set of attributes associated with a predetermined sequence of one or more pressure gestures stored in the pressure gesture repository 22. If the attributes match within a configured margin of error, then the pressure gesture module 20 may send an instruction that the touchscreen should be unlocked.

In one embodiment, if the pressure gesture module 20 determines that the user has successfully unlocked the touchscreen, then the pressure gesture module 20 may play an audio response to indicate that electronic device 4 has been successfully unlocked.

If the attributes do not match within the configured margin of error, then the pressure gesture module 20 may allow the user to re-enter the sequence of pressure gestures for some number of attempts. If the number of attempts exceeds a threshold, the pressure gesture module 20 may send an instruction to display a conventional unlock screen that prompts to the user to enter a PIN, password or swipe gesture to unlock the touchscreen 18.

A method and system for unlocking an electronic device has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for unlocking a touchscreen of an electronic device, the method performed by software component executing on at least one processor comprising:
detecting a sequence of one or more press gestures on the touchscreen; and
responsive to determining that each individual pressure gesture comprising the sequence of one or more pressure gestures is applied for a specific period of time to a specific area of the touchscreen, unlocking the touchscreen.

2. The method of claim 1, wherein each of the individual press gestures comprising the sequence of one or more press gestures includes one or more single finger presses, one or more simultaneous multi-finger presses, or any combination of single and multi-finger presses.

3. The method of claim 1, wherein detecting a sequence of one or more press gestures on the touchscreen further comprises: a pressure sensor detecting the one or more press gestures in a form of contact points made on the touchscreen and collecting data regarding attributes of the one or more pressure gestures.

4. The method of claim 3, wherein the attributes for each one of the individual pressure gestures comprise:
a number of fingers in the individual pressure gesture,
a time duration of the individual pressure gesture, and
a position on the touchscreen.

5. The method of claim 4, wherein the attributes further comprise: an amount of pressure applied for each of the individual pressure gestures, and an allowed time interval between the individual pressure gestures.

6. The method of claim 3, wherein the determining further comprises:
comparing a first set attributes collected for the individual pressure gestures comprising the sequence of one or more pressure gestures to a second set of attributes associated with a predetermined sequence of one or more pressure gestures.

7. The method of claim 7, further comprising: sending an instruction that the touchscreen should be unlocked when the first set of attributes match the second set of attributes within a configured margin of error.

8. The method of claim 7, further comprising:
allowing the user to re-enter the sequence of one or more pressure gestures for a number of attempts; and
when the number of attempts to reenter the sequence exceeds a threshold, sending an instruction to display an unlock screen prompting the user to enter one of a PIN, a password, or a swipe gesture to unlock the screen.

9. The method of claim 7, wherein the attributes are configurable by a user during configuration of a predetermined sequence of pressure gestures, the attributes further comprising: an area of a press point applied for each of the individual press gestures, and an allowed maximum and minimum area for each of the individual press gestures.

10. An executable software product stored on a computer-readable medium containing program instructions for unlocking a touchscreen of an electronic device, the program instructions for:
detecting a sequence of one or more press gestures on the touchscreen; and
responsive to determining that each individual pressure gesture comprising the sequence of one or more pressure gestures is applied for a specific period of time to a specific area of the touchscreen, unlocking the touchscreen.

11. The software product of claim 10, wherein each of the individual press gestures comprising the sequence of one or more press gestures includes one or more single finger presses, one or more simultaneous multi-finger presses, or any combination of single and multi-finger presses.

12. The software product of claim 10, wherein the program instructions for detecting a sequence of one or more press gestures on the touchscreen further include: a pressure sensor detecting the one or more press gestures in a form of contact points made on the touchscreen and collecting data regarding attributes of the one or more pressure gestures.

13. The software product of claim 12, wherein the attributes for each one of the individual pressure gestures comprise:
a number of fingers in the individual pressure gesture,
a time duration of the individual pressure gesture, and
a position on the touchscreen.

14. The software product of claim 13, wherein the attributes further comprise: an amount of pressure applied for each of the individual pressure gestures, and an allowed time interval between the individual pressure gestures.

15. The software product of claim 12, wherein the program instructions for the determining further comprise program instructions for:
comparing a first set attributes collected for the individual pressure gestures comprising the sequence of one or more pressure gestures to a second set of attributes associated with a predetermined sequence of one or more pressure gestures.

16. The software product of claim 15, further comprising program instructions for: sending an instruction that the touchscreen should be unlocked when the first set of attributes match the second set of attributes within a configured margin of error.

17. The software product of claim 15, further comprising program instructions for:
allowing the user to re-enter the sequence of one or more pressure gestures for a number of attempts; and
when the number of attempts to reenter the sequence exceeds a threshold, sending an instruction to display an unlock screen prompting the user to enter one of a PIN, a password, or a swipe gesture to unlock the screen.

18. The software product of claim 15, wherein the attributes are configurable by a user during configuration of a predetermined sequence of pressure gestures, the attributes further comprising: an area of a press point applied for each of the individual press gestures, and an allowed maximum and minimum area for each of the individual press gestures.

19. An electronic device, comprising:
a touchscreen;
a pressure sensor coupled to the touchscreen;
a processor coupled to the pressure sensor; and
a software component executed by the processor that is configured to:
detect a sequence of one or more press gestures on the touchscreen; and
responsive to determining that each individual pressure gesture comprising the sequence of one or more pressure gestures is applied for a specific period of time to a specific area of the touchscreen, unlock the touchscreen.

20. The electronic device of claim 19, wherein each of the individual press gestures comprising the sequence of one or more press gestures includes one or more single finger presses, one or more simultaneous multi-finger presses, or any combination of single and multi-finger presses.

21. The electronic device of claim 19, wherein the pressure sensor detects the one or more press gestures in a form of contact points made on the touchscreen and collects data regarding attributes of the one or more pressure gestures.

22. The electronic device of claim 19, wherein the attributes for each one of the individual pressure gestures comprise:
a number of fingers in the individual pressure gesture,
a time duration of the individual pressure gesture, and
a position on the touchscreen.

23. The electronic device of claim 22, wherein the attributes further comprise: an amount of pressure applied for each of the individual pressure gestures, and an allowed time interval between the individual pressure gestures.

24. The electronic device of claim 21, wherein the software component is further configured to:
compare a first set attribute collected for the individual pressure gestures comprising the sequence of one or more pressure gestures to a second set of attributes associated with a predetermined sequence of one or more pressure gestures.

25. The electronic device of claim 24, wherein the attributes are configurable by a user during configuration of a predetermined sequence of pressure gestures, the attributes further comprising: an area of a press point applied for each of the individual press gestures, and an allowed maximum and minimum area for each of the individual press gestures.
